(19) United States
(12) Patent Application Publication
(10) Pub. No.: US 2020/0166954 A1
(43) Pub. Date: May 28, 2020

(54) COMPREHENSIVE MULTI-AGENT ROBOTICS MANAGEMENT SYSTEM

(71) Applicant: ARCHE INFORMATION INC., Toyama (JP)

(72) Inventor: Hiroki CHIBA, Toyama (JP)

(21) Appl. No.: 16/776,181

(22) Filed: Jan. 29, 2020

Related U.S. Application Data
(63) Continuation of application No. 16/494,886, filed on Sep. 17, 2019.

(30) Foreign Application Priority Data
Oct. 4, 2017 (SG) 10201708171Q

(51) Int. Cl. G05D 1/02; G01C 21/20

(52) U.S. Cl. CPC G05D 1/0297; G05D 1/0282; G05D 2201/0216; G01C 21/206; G05D 1/0274

(57) ABSTRACT

A system for managing autonomous vehicles within an indoor environment is provided. The system may include a plurality of devices placed at a plurality of fixed locations within the indoor environment to create a chain of devices, each of which may contribute in creating a novel navigation system that is referred to as “Global Chained-Vision Navigation System”. The system may include a plurality of robots configured to autonomously scan the indoor environment to generate a map in real time for the indoor environment. Each robot of the plurality of robots may determine the location of itself using a subset of the plurality of devices. The system may include a set of vehicles configured to move autonomously in the indoor environment based on the map. The system may further include a server configured to receive data related to the map from the plurality of robots.

### CROSS-REFERENCE TO RELATED APPLICATIONS:

This application is a continuation of U.S. application Ser. No. 16/494,886 filed on Sep. 17, 2019, which is a 371 of International Application No. PCT/JP2018/036761, filed on Oct. 2, 2018.

### TECHNICAL FIELD

Various aspects of this disclosure generally relate to multi-agent systems, and more particularly, to a multi-agent robotics management system for managing different types of autonomous vehicles within an indoor environment.

### BACKGROUND

A multi-agent system is a computerized system composed of multiple interacting intelligent agents within an environment. Multi-agent systems can be used to solve problems that are difficult or impossible for an individual agent or a monolithic system to solve. Intelligence may include some methodic, functional, procedural approach, algorithmic search or reinforcement learning. Multi-agent systems consist of agents and their environment. The agents in a multi-agent system may be software agents, robots, humans, or human teams. A multi-agent system may contain combined human-agent teams.

Vehicular automation involves the use of mechatronics, artificial intelligence, and a multi-agent system to assist a vehicle's operator. A vehicle relying on automation may be referred to as a robotic or autonomous vehicle. An autonomous vehicle may collect various types of items at one location and transport them to their destinations in an indoor environment (e.g., a warehouse or a factory) within a short period of time with minimal human intervention.

In a traditional self-driving enabled system, such as Automated Guided Vehicles (AGVs) and Automated Guided Carts (AGCs), a magnetic reading device may be attached to the lower part of the vehicle body. The vehicle may run along a route by sensing the magnetic force generated by magnetic tapes placed on the floor of the facility that the vehicle operating on. In such a system, the vehicle receives a task from the server and starts moving to the next branching point, where it reads a label and decide which way to go. The acceleration and the maneuver of the vehicle is very limited. In such a system, when there is an obstacle on the guide line, there is no way to avoid the obstacle or move around it, thus the vehicle cannot proceed until the obstacle is removed. A vehicle in such a system cannot avoid an oncoming dynamic objects at an arbitrary place. The following vehicle cannot overtake the preceding vehicle at an arbitrary place in such a system either. Moreover, the magnetism may not be read correctly on a metal floor, thus the car cannot be guided correctly. Therefore, such a system cannot be used on a metal floor. Furthermore, it may be necessary to set the actions (e.g., the direction of turning at the intersection, proceed or stop, etc.) and the running route on the guide lines in advance. If circumstances (e.g., workers, equipment, cargos, etc.) change, such a system cannot change the action unless the guide lines are changed. And it is not realistic to modify the guide lines frequently for the above reasons.

In another traditional self-driving enabled system, a machine-readable optical label (e.g., a Quick Response (QR) code) in which a driving command is embedded may be painted onto the driving floor. An optical reading device may be attached to the lower part of the car body to read the machine-readable optical label. The car may control its motions, such as traveling direction, deceleration, acceleration, stop, etc., by reading the optical labels on the floor. In such a system, when adding or modifying the driving command, it may be difficult for the vehicle to operate due to misplacement or removal of the optical labels. Furthermore, if a label is worn out or contaminated, the optical labels may be difficult to read. There were reported cases of optical labels that cannot be scanned due to the reflection of light such as illumination. Since only the predefined actions (such as direction of turning at the intersection, progress or stop) are embedded in the optical labels, it is difficult to change the action to adopt to the changes of the surroundings (e.g., position of workers, equipment, cargos, etc.).

In yet another traditional self-driving enabled system, a laser irradiation device may be installed on a wall surface or a ceiling of the indoor environment. A signal emitted from the laser irradiation device may be received by a reception device attached to the upper part of the vehicle body. The received signal may control the direction of movement of the vehicle, deceleration, acceleration, stop, etc. However, structures and workers in the environment may generate blind spots for laser irradiated from ceilings and walls, and the reception device may not be able to receive the laser due to the blind spots. As a result, the vehicle may not be able to determine its position and may not be able to move around according to the instructions communicated through the laser signal. Not to mention that, laser irradiation devices consume a lot of power; and in any power supply interruption, the whole system will fall down.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a system for managing autonomous vehicles within an indoor environment is provided. The system may include a plurality of devices placed at a plurality of fixed locations within the indoor environment. The system may include a plurality of robots configured to automatically scan the indoor environment to generate a map in real time for the indoor environment and keep updating it without any human interference. Each robot of the plurality of robots may determine the location of itself using a subset of the plurality of devices. If that was not possible for any reason, the robot will send a request to the server asking for details about the current location. The system may include a set of vehicles configured to move autonomously in the indoor environment based on the auto-generated map. The system may involve a server configured to receive the gathered data related to the map and the dynamic objects within the map from the plurality of robots.

In another aspect of the disclosure, a method, a computer readable medium, and an apparatus for managing autonomous vehicles within an indoor environment are provided. The apparatus may receive a plurality of radio frequency (RF) signals broadcasted by a plurality of devices. The plurality of devices may be placed at a plurality of fixed locations within the indoor environment. The apparatus may determine the location of a robot based on the plurality of radio frequency signals. The apparatus may scan the indoor environment to generate a map in real time for the indoor environment. A set of vehicles may move autonomously in the indoor environment based on the updated map. The apparatus may send data related to the map to a server which in turn enables the server to communicate with all robots and vehicles to help them make better decisions. The apparatus may send distances between a subset of the set of vehicles and the robot to the server. The apparatus may send the location of the robot to the server. The apparatus may calculate locations of a vehicle based on locations of the robots located within the vehicle's range and the vehicle's distances to these robots.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a multi-agent robotics management system that manages different types of robots running in an indoor environment.

FIG. 2 is a diagram illustrating an example of maps generated by the multi-agent robotics management system described above in FIG. 1.

FIG. 3 is a diagram illustrating an example of using the beacons broadcasting signals of their own locations (fixed), where an apparatus uses a plurality of these signals to calculate its own location in a way that the margin of error will not exceed ±1 inch (more signals received more precise location determination).

FIG. 4 is a diagram illustrating an example of using locations of multiple robots to determine the location of a vehicle.

FIG. 5 is a flowchart of a method of operating a vehicle in the multi-agent robotics management system described above with reference to FIG. 1.

FIG. 6 is a flowchart of a method of vehicle speed control and object avoidance.

FIG. 7 is a flowchart of a method of vehicle path planning.

FIG. 8 is a flowchart of a method of robot problem solving.

FIG. 9 is a flowchart of performing mapping and localization by the robots.

FIG. 10 is a conceptual data flow diagram illustrating the data flow between different means/components in an exemplary apparatus.

FIG. 11 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of a multi-agent robotics management system will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media may include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

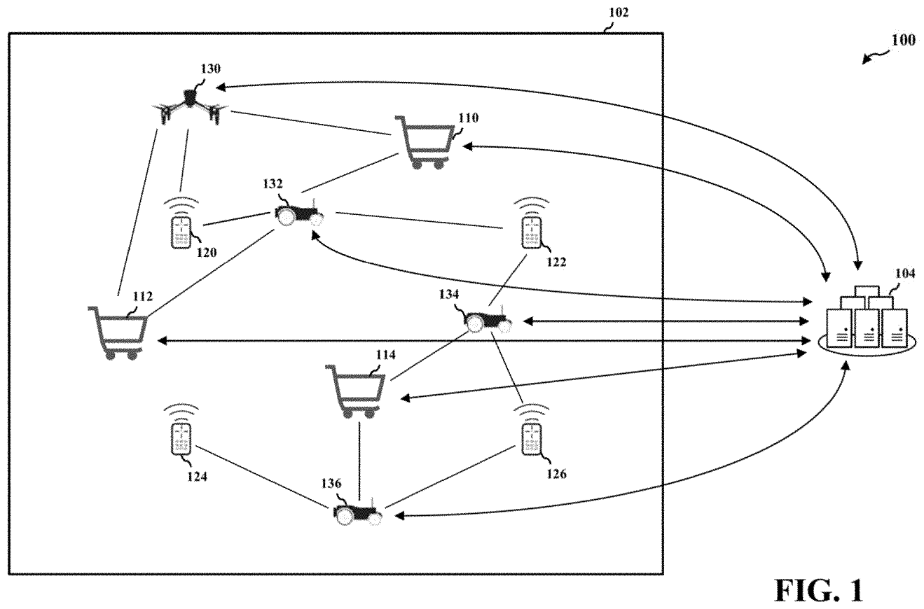

FIG. 1 is a diagram illustrating an example of a multi-agent robotics management system 100 that manages different types of robots running in an indoor environment 102. In one embodiment, the indoor environment 102 may be an industrial environment such as a warehouse, a factory, etc. In one embodiment, the indoor environment 102 may be a building, an airport, a shopping mall, a sports venue, etc. In the example, the multi-agent robotics management system 100 may include a server 104, multiple beacons 120, 122, 124, 126, multiple vehicles 110, 112, 114, and multiple robots 130, 132, 134, 136.

The server 104 may be responsible for managing all robots and devices (e.g., the beacons, the vehicles, the robots) deployed in the indoor environment 102. In one embodiment, the server 104 may be a computer program or one or more computing devices that provide resources and computing power for computer programs or devices deployed in the indoor environment 102. In one embodiment, information gathered by the devices deployed in the indoor environment 102 may be analyzed and stored at the server 104, and may subsequently be used to manage and improve the operations of the devices. In various embodiments, a set of application programs may be installed on the server 104 and the devices (e.g., the beacons, the robots, the vehicles). The set of application programs may provide tools and services that enable devices to communicate with each other, make decisions for each other, and enable project managers to take control and monitor running robots and vehicles. In one embodiment, the server 104 may be located within the indoor environment 102. In another embodiment, the server 104 may be physically located outside of the indoor environment 102.

A beacon (e.g., the beacon 120, 122, 124, or 126) may be a small device that is installed at a predefined fixed location. In some embodiments, the beacon may provide nearby robots with the measurements of distances between the beacon and the robots. This piece of information may be used later on by the nearby robots to calculate the location coordinates of these robots and send the location coordinates to the server 104. For example, the beacon 120 may provide robot 130 with the measurement of distance between the beacon 120 and the robot 130. The beacon 120 may also provide robot 132 with the measurement of distance between the beacon 120 and the robot 132. The robots 130 and 132 may calculate their own location coordinates partially based on the measurements of distances provided by the beacon 120.

A vehicle (e.g., the vehicle 110, 112, or 114) may consist of three major parts: a control unit, a motor unit, and a sensor unit. The control unit may control the operations of the vehicle. The motor unit may facilitate the movement of the vehicle. The sensor unit may detect events or changes in the indoor environment 102 and send the information to the control unit. Therefore, the vehicle may be able to act autonomously without waiting for new instructions from the server once a change in the indoor environment 102 is detected by the sensor unit.

All of the three major parts may be mounted on a regular shopping or moving cart to make the shopping or moving cart into a completely autonomous robot. In some embodiments, a vehicle may be self-driving and may move items to distribution centres more efficiently than humans. In some embodiments, a vehicle may have three modes: autonomous, controlled, and manual. Under the autonomous mode, the vehicle may operate without any human intervention. Under the controlled mode, the vehicle may operate with occasional human intervention. Under the manual mode, the vehicle may be operated by a human manually.

Each of the robots 132, 134, or 136 may be an overland robot. An overland robot may be designed to scan and draw a three dimensional (3D) map of the indoor environment 102 and exchange information related to the 3D map with the server 104. In one embodiment, an overland robot may be also responsible of identifying nearby vehicles' locations and update the server 104 accordingly. For example, the robot 136 may be responsible of identifying the location of the vehicle 114 and update the server 104 with information related to the location of the vehicle 114. In some embodiment, overland robots may cooperate to generate a routing map that contains virtual paths and virtual stations and keep the routing map updated. In some embodiment, the routing map may be generated based on the 3D map of the indoor environment 102.

In one embodiment, the robot 130 may be a flying robot. The robot 130 may keep maintaining the 3D map by providing indoor eye-in-the-sky monitoring services and raise an immediate awareness of any emergency cases.

In one embodiment, the multi-agent robotics management system 100 may be used to collect a small amount of various types of products efficiently in a warehouse work environment, e.g., as part of logistics operation. In one embodiment, the multi-agent robotics management system 100 may be used to transport equipment, materials, and parts in the factory to the destination efficiently. In one embodiment, the multi-agent robotics management system 100 may be applied to return carts to cart stations automatically after passengers finish using the carts in an airport or after it notices the critical battery level of the vehicle.

In one embodiment, the multi-agent robotics management system 100 may identify vehicle coordinates in real time even if the information changes in the indoor environment 102. In one embodiment, real-time changes in collected information (e.g., in-building maps, equipment, workers, cargo, products, etc.) may be detected by sensors. Based on the detected changes, the multi-agent robotics management system 100 may calculate the coordinates of the vehicle position in the map.

In one embodiment, the multi-agent robotics management system 100 may recalculate the optimal route in real time even if there is a change in the indoor environment 102. Therefore, the vehicle may self-drive based on the optimal driving-route recalculated in real time. In one embodiment, since the travel route can be determined in real time, the driving-route may adapt to changes in the external environment (e.g., exhaustion of facility equipment). In one embodiment, since it is difficult to judge the optimal driving-route from a current location of the vehicle to the destination in real time, there is no need to set the driving route in advance.

In one embodiment, a vehicle may to able to run while solving issues occurring during driving. In such an embodiment, since the movement of the oncoming vehicle may be detected earlier by the multi-agent robotics management system 100, a vehicle may be able to prepare beforehand plans to avoid the oncoming vehicle at an arbitrary place automatically. In such an embodiment, a following vehicle may be able to overtake a preceding vehicle at an arbitrary place automatically. In such an embodiment, since the multi-agent robotics management system 100 may be able to detect an obstacle and perform forward planning, a vehicle may be able to travel around an obstacle automatically or avoid that path from the beginning.

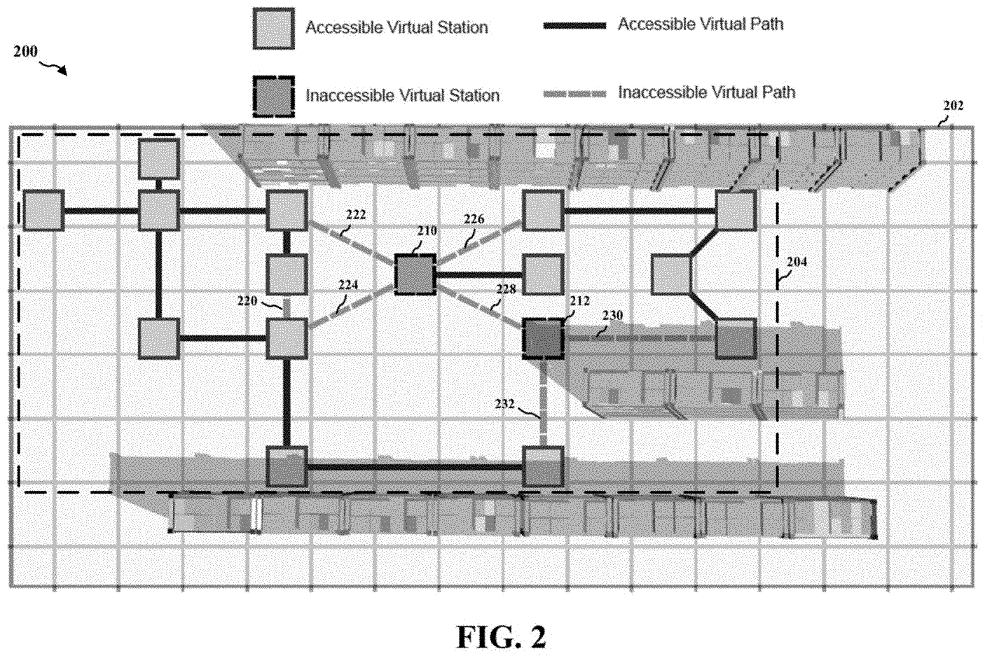

FIG. 2 is a diagram 200 illustrating an example of maps generated by the multi-agent robotics management system 100 described above in FIG. 1. In one embodiment, the overland robots (e.g., the robots 132, 134, and 136) may be dispatched to scan the environment (e.g., the indoor environment 102) and draw a 3D map 202. The robots may keep identifying the edges of the potential paths and create a routing map 204, in which virtual stations and virtual paths are added and the optimal routes may be evaluated. In one embodiment, the flying robots (e.g., the robot 130) may be deployed to scan the environment for any virtual station or virtual path that cannot ‘temporarily’ be accessed to assess the situation and report it to the multi-agent robotics management system 100. The system, then, will decide whether to change their status to “Inaccessible” or keep it as it was. Switching the status of a path to “Inaccessible” means that it will not be considered by the system when the forward planning take place, and it will be totally ignored as if there is no such a path in that particular part of the map. Once the physical accessibility situation of an inaccessible virtual path improves, the flying robots may detect the change and report that to the system with a recommendation to switch the accessibility status back again to “Accessible”, leaving the multi-agent robotics management system 100 to take the choice of status modification. This is also what happens with virtual stations' statuses, except that when the system decide switch a station status to “Inaccessible” station, all those paths branching from the station will also be inaccessible. If the multi-agent robotics management system 100 decides to switch the status of the virtual station back again to “Accessible”, that does not necessarily mean that status of all paths connected to the virtual station will also change to “Accessible”. The system may request more information from all the robots nearby those paths and gather more information without disturbing their original tasks to decide which one is subjected to status modification.

For example, in the routing map 204, the virtual stations 210, 212 and the virtual paths 220, 222, 224, 226, 228, 230, 232 may be flagged as inaccessible, while the other virtual paths and virtual stations may be flagged as accessible. The updates of the status of the virtual paths and virtual stations may help in arranging a set of constraints of the environment at a certain time to optimize the searching solutions of finding the optimal route.

In one embodiment, the operations performed by the robots are iterative and non-stop. The robots keep scanning the environment looking for any changes within the environment to update the maps (e.g., the 3D map 202 and the routing map 204) on the server (e.g., the server 104).

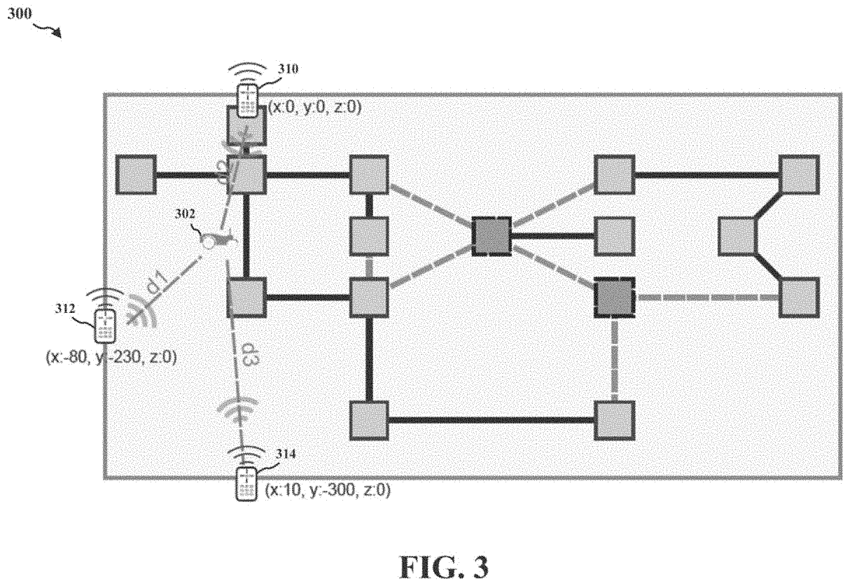

FIG. 3 is a diagram 300 illustrating an example of using the beacons broadcasting signals of their own locations (fixed), where an apparatus uses a plurality of these signals to calculate its own location in a way that the margin of error will not exceed ±1 inch (more signals received more precise location determination). In one embodiment, the robot 302 may be one of robots 132, 134, 136 described above with reference to FIG. 1. In one embodiment, each beacon in this example may be similar to one of the beacons 120, 122, 124, 126 described above with reference to FIG. 1.

In the example, during the scanning process described above with reference to FIG. 2, the robot 302 may receive broadcasted signals from nearby beacons 310, 312, and 314. Each of the received signal may include an identifier of the beacon that broadcasts the signal. For example, the broadcasted signal received from the beacon 310 may include the identifier of the beacon 310. In one embodiment, the robot 302 may be able to determine the distance between a beacon and the robot 302 based on the received signal. For example and in one embodiment, the robot 302 may be able to determine the distance (d1) between the beacon 312 and the robot 302 based on the signal received from the beacon 312. In one embodiment, the distance between a beacon and the robot 302 may be estimated based on the measured signal strength (e.g., received signal strength indicator (RSSI)) of the signal received from the beacon. In one embodiment, since the locations of the beacons 310, 312, and 314 are fixed and known (e.g., via the identifiers), the robot 302 may be able to calculate its location based on the locations of the beacons 310, 312, 314 and the distances (d1, d2, d3) between the robot 302 and the beacons 310, 312, 314.

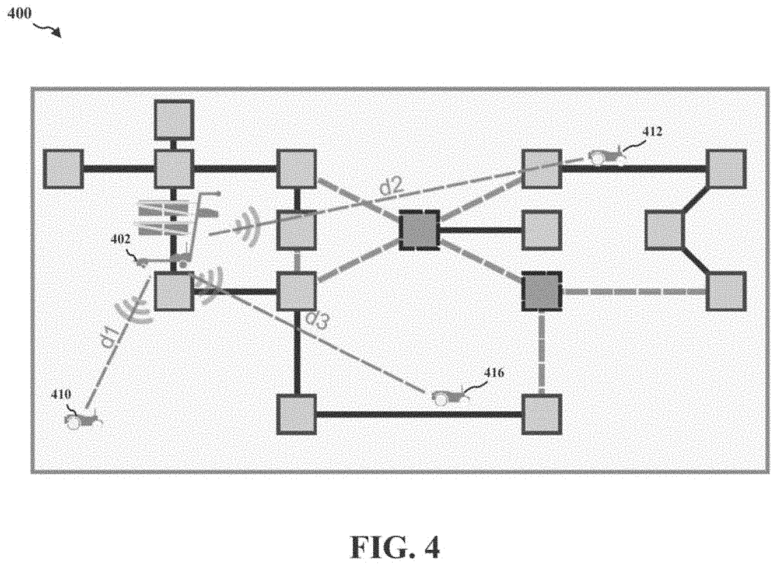

FIG. 4 is a diagram 400 illustrating an example of using locations of multiple robots to determine the location of a vehicle 402. In one embodiment, the vehicle 402 may be one of vehicles 110, 112, 114 described above with reference to FIG. 1. In one embodiment, each robot in this example may be similar to one of the robots 132, 134, 136 described above with reference to FIG. 1.

In the example, during the scanning process described above with reference to FIG. 2, each of the robots 410, 412, 416 may receive a broadcasted signal from the vehicle 402. The received signal may include an identifier of the vehicle 402. In one embodiment, each of the robots 410, 412, 416 may be able to determine the distance between the vehicle 402 and the robot based on the received signal. For example and in one embodiment, the robot 410 may be able to determine the distance (d1) between the vehicle 402 and the robot 410 based on the signal received from the vehicle 402. In one embodiment, the distance between the vehicle 402 and a robot may be estimated based on the measured signal strength (e.g., RSSI) of the signal received from the vehicle 402. In one embodiment, since the locations of the robots 410, 412, 416 may be calculated (as described above with reference to FIG. 3), the location of the vehicle 402 may be calculated based on the locations of the robots 410, 412, 416 and the distances (d1, d2, d3) between the vehicle 402 and the robots 410, 412, 416. Those robots may not only evaluate the location of the vehicles against their own locations; but also against each other. The robots may use the calculated location of vehicle 402 to confirm with the multi-agent system the location of another vehicle located on different part of the map. For example, if the calculated coordination of vehicle 402 suggests that the location of the same vehicle is (x:20 m, y:20 m, z:0.3) and the coordination of another vehicle (not shown) is (x:30 m, y:20 m, z:0.3 m) but nearby robots suggests that the distance between those two vehicles (since they receive signals broadcasted by both of them) is 10.2 m which is larger than what it is supposed to be, then the multi-agent system will apply corrective measures to reduce that margin of error even further.

In one embodiment, each of the robots 410, 412, 416 may send its distance (e.g., d1, d2, or d3) to the vehicle 402 to a server (e.g., the server 104). The server may receive loads of information coming from different resources about a specific vehicle to keep re-evaluating its location using Pythagorean theorem:

d=\sqrt{(x₁−x₀)₂+(y₁−y₀)²+(z₁−z₀)²}

where (x₁, y₁, z₁) is the location of the first resource (whether it is a robot, beacon, or even another vehicle), and (x₀, y₀, z₀) is the location of current evaluated vehicle, and d is the distance between them both. Since all deployed hardware (including beacons, robots, and vehicles) contribute in creating what may be referred to as a Locations Chain Network; a reliable global vision system will be initiated relying on the intensive information flow generated by numerous diverse resources and feeds into the multi-agent system. So even if one of these dispatched mechatronic machines encounter serious problems with their navigation system, the others will keep updating it with all information needed to at least take it back to its home base autonomously.

For example, each of the robots 410, 412, 416 may send its location and the distance to the vehicle 402 to the server. The server may be able to calculate the location of the vehicle 402 based on the received locations of the robots 410, 412, 416 and the received distances (d1, d2, d3) between the vehicle 402 and the robots 410, 412, 416. In one embodiment, further processing of the incoming information at the server may improve the precision of the localization process.

In one aspect of the disclosure, a system (e.g., the multi-agent robotics management system 100) for managing autonomous vehicles (e.g., the vehicles 110, 112, 114) within an indoor environment (e.g., the indoor environment 102) is provided. The system may include a plurality of devices (e.g., the beacons 120, 122, 124, 126) placed at a plurality of fixed locations within the indoor environment. The system may include a plurality of robots (e.g., the robots 130, 132, 134, 136) configured to automatically scan the indoor environment to generate maps (e.g., the routing map 204) in real time for the indoor environment. Each robot of the plurality of robots may determine a location of the robot using a subset of the plurality of devices. The system may include a set of vehicles (e.g., the vehicles 110, 112, 114) configured to move autonomously in the indoor environment based on the generated map. In the present disclosure, a subset may mean a proper subset or an equal set.

In one embodiment, the map may be a routing map including a plurality of virtual paths and a plurality of virtual stations. In one embodiment, the plurality of robots may further detect that a subset of the plurality of virtual paths or a subset of the plurality of virtual stations (e.g., the the virtual stations 210, 212, the virtual paths 220, 222, 224, 226, 228, 230, 232) becomes inaccessible.

In one embodiment, for each robot of the plurality of robots, to determine the location of the robot using the subset of the plurality of devices, the robot may be configured to: receive a plurality of radio frequency signals broadcasted by the subset of the plurality of devices, where the plurality of radio frequency signals may include identifiers of the subset of the plurality of devices; determine locations of the subset of the plurality of devices based on the identifiers; measure distances from the subset of the plurality of devices to the robot based on the plurality of radio frequency signals; and calculate the location of the robot based on the fixed locations of the subset of the plurality of devices and the distances from the subset of the plurality of devices to the robot.

In one embodiment, for each vehicle of the set of vehicles, a location of the vehicle may be determined based on locations of a subset of the plurality of robots and distances from the subset of the plurality of robots to the vehicle. In one embodiment, for each vehicle of the set of vehicles, each robot of the subset of the plurality of robots may receive a radio frequency signal broadcasted by the vehicle. The distances from the subset of the plurality of robots to the vehicle may be measured based on the radio frequency signal received by the subset of the plurality of robots.

In one embodiment, the system may further include a server configured to receive data related to the map from the plurality of robots. In one embodiment, the server may be further configured to: receive, from each robot of the plurality of robots, distances between a subset of the set of vehicles and the robot; receive the locations of the plurality of robots; and calculate locations of the set of vehicles based on the received distances and the received locations of the plurality of robots. In one embodiment, the plurality of robots may generate the map based on the locations of the plurality of robots.

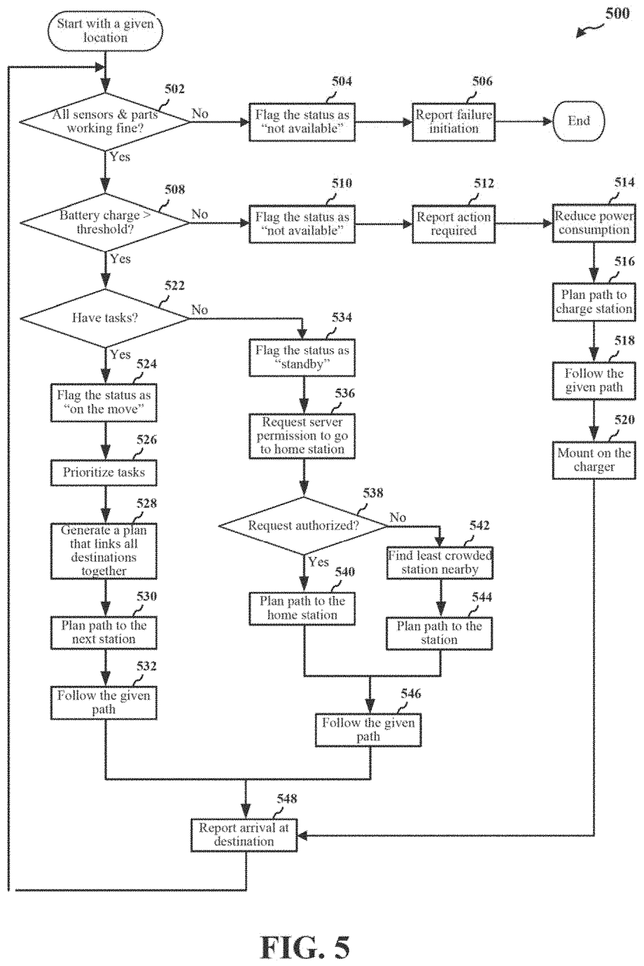

FIG. 5 is a flowchart 500 of a method of operating a vehicle in the multi-agent robotics management system 100 described above with reference to FIG. 1. The method may be performed by an apparatus. The apparatus may include the vehicle (e.g., the vehicle 110, 112, or 114), or a server (e.g., the server 104), or a combination of the vehicle and the server. The vehicle may be initially located at a given location known as home base and works as charger such that if the vehicle mounted to the home base, the charging process may start.

At 502, the apparatus may determine whether all sensors and mechanical parts of the vehicle are working as expected. After conducting few system initiating test, if all sensors and mechanical parts of the vehicle are working fine, the apparatus may proceed to 508. Otherwise, the apparatus may proceed to 504.

At 504, the apparatus may flag the status of the vehicle as ‘not available’. At 506, the apparatus may report (e.g., to the server) the failure of initiating operations of the vehicle. In one embodiment, the report may indicate that the vehicle is unable to move at the current location and include the coordinates of the current location. The apparatus may then terminate the operation of the vehicle.

At 508, the apparatus may determine whether the battery charge level of the vehicle is above a certain threshold (e.g., 10% charged). If the battery charge level of the vehicle is above the threshold, the apparatus may proceed to 522. Otherwise, the apparatus may proceed to 510.

At 510, the apparatus may flag the status of the vehicle as ‘not available’. At 512, the apparatus may report that a certain action is required. For example, the apparatus may request the vehicle to be moved to a charge station.

At 514, the apparatus may reduce power consumption of the vehicle. For example, the apparatus may turn off all unnecessary sensors and mechanical parts of the vehicle to reduce power consumption.

At 516, the apparatus may plan the path for the vehicle to move to the charge station. At 518, the apparatus may follow the direction of the planned path. For example, the apparatus may direct the vehicle to move to the next station in the planned path. During the movement of the vehicle, the original task of apparatus may not be disturbed as it may keep re-evaluating the planned path, observing the environment, and reporting any changes in the environment to the server.

At 520, the vehicle may align itself to the charger at the charging station and start the mounting process. The apparatus may stay standby to provide any necessary assistance during this process until the moment the vehicle is successfully mounted on the charger. The apparatus may then proceed to 548.

At 522, the apparatus may determine whether the vehicle has tasks assigned to it. If the vehicle has tasks assigned, the apparatus may proceed to 524. Otherwise, the apparatus may proceed to 534.

At 524, the apparatus may flag the status of the vehicle as ‘on the move’. At 526, the apparatus may prioritize the tasks assigned to the vehicle.

At 526, the apparatus may prioritize the tasks assigned to the vehicle. For example, the apparatus may select the most urgent task to perform first, then select the next urgent task to perform, and so on.

At 528, the apparatus may perform searching by generating a comprehensive plan that links all destinations together. At 530, the apparatus may plan a path for moving the vehicle to the next station in the comprehensive plan. In one embodiment, the apparatus may provide the vehicle with directions for moving to the next station of the current station.

At 532, the apparatus may follow the direction of the planned path to move the vehicle to the next station. During the movement of the vehicle, the apparatus may keep re-evaluating the planned path, observing the environment, and reporting any changes in the environment to the server. The apparatus may then proceed to 548.

At 534, the apparatus may flag the status of the vehicle as ‘standby’. At 536, the apparatus may request the server for permission to move the vehicle to the home station.

At 538, the apparatus may determine whether the request is authorized by the server. If the request is authorized, the apparatus may proceed to 540. Otherwise, the apparatus may proceed to 542.

At 540, the apparatus may plan a path for the vehicle to move to the home station. The apparatus may then proceed to 546.

At 542, the apparatus may find the least crowded station near the vehicle. At 544, the apparatus may plan a path for the vehicle to move to the least crowded station nearby.

At 546, the apparatus may follow the planned path to move the vehicle. During the movement of the vehicle, the apparatus may keep re-evaluating the planned path, observing the environment, and reporting any changes in the environment to the server.

At 548, the apparatus may report the vehicle's arrival at the destination (e.g., the next station). The apparatus may then loop back to 502 to perform the next iteration of the method.

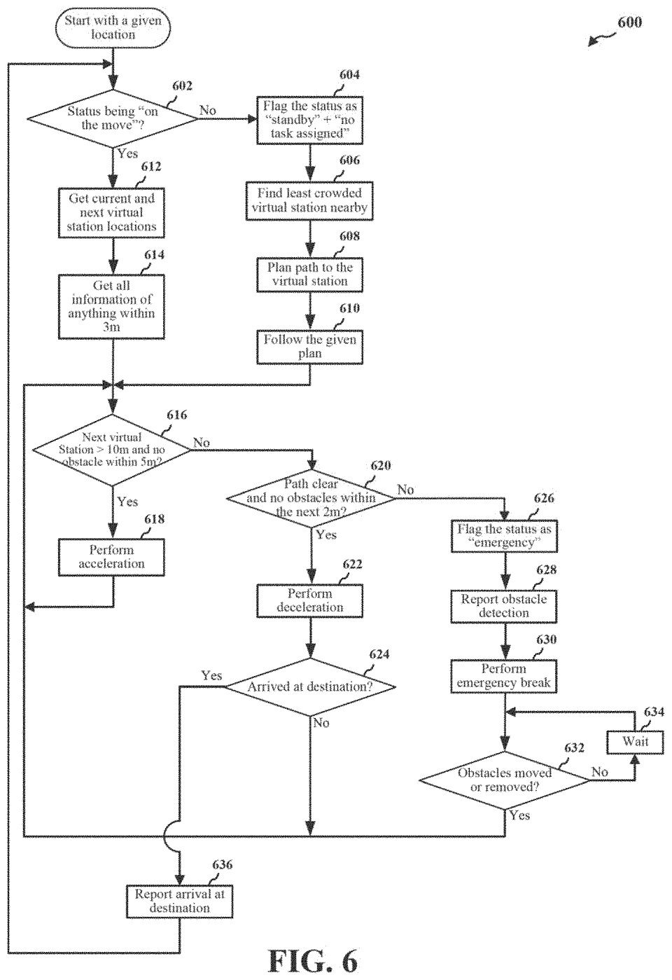

FIG. 6 is a flowchart 600 of a method of vehicle speed control and object avoidance. The method may be performed by an apparatus. The apparatus may include a vehicle (e.g., the vehicle 110, 112, or 114), or a server (e.g., the server 104), or a combination of the vehicle and the server. The vehicle may be initially located at a given location. In one embodiment, the operations performed by the method may be the operations described above with reference to 532, 546, or 518 in FIG. 5.

At 602, the apparatus may determine whether the vehicle's status is ‘on the move’. If the vehicle's status is ‘on the move’, the apparatus may proceed to 612. Otherwise, the apparatus may proceed to 604.

At 604, the apparatus may flag the status of the vehicle as ‘standby’ and ‘no task assigned’. At 606, the apparatus may find the least crowded virtual station near the vehicle.

At 608, the apparatus may plan a path for the vehicle to move to the least crowded virtual station nearby. At 610, the apparatus may follow the direction of the planned path to move the vehicle to the next virtual station. The apparatus may then proceed to 616.

At 612, the apparatus may get the locations of the vehicle's current virtual station and next virtual station. In one embodiment, the locations may be stored at the server.

At 614, the apparatus may get all information of anything within 3 meters of the vehicle. In one embodiment, some of the information may be stored on the server. In one embodiment, some of the information may be collected by the sensor unit of the vehicle.

At 616, the apparatus may determine whether the next virtual station is farther than 10 meters away from the vehicle and there is no obstacle within the next 5 meters on the vehicle's path to the next virtual station. If the next virtual station is farther than 10 meters away from the vehicle and there is no obstacle within the next 5 meters on the vehicle's path to the next virtual station, the apparatus may proceed to 618. Otherwise, the apparatus may proceed to 620.

At 618, the apparatus may direct the vehicle to perform acceleration (e.g., up to 5 km/h). The apparatus may then loop back to 616.

At 620, the apparatus may determine whether the path to the next virtual station is clear and there is no obstacles within the next 2 meters on the vehicle's path to the next virtual station. If the path to the next virtual station is clear and there is no obstacles within the next 2 meters on the vehicle's path to the next virtual station, the apparatus may proceed to 622. Otherwise, the apparatus may proceed to 626.

At 622, the apparatus may direct the vehicle to perform deceleration (e.g., down to 1 km/h). At 624, the apparatus may determine whether the vehicle has arrived at the destination (e.g., the next virtual station). If the vehicle has arrived at the destination, the apparatus may proceed to 636. Otherwise, the apparatus may loops back to 616.

At 636, the apparatus may report (e.g., to the server) the vehicle's arrival at the destination. The apparatus may then loops back to 602 to start the next iteration of the method.

At 626, the apparatus may flag the status of the vehicle as ‘emergency’. At 628, the apparatus may report (e.g., to the server) the detection of obstacle. In one embodiment, the apparatus may indicate that the vehicle needs to perform emergency break.

At 630, the apparatus may direct the vehicle to perform emergency break. In one embodiment, the apparatus may direct the vehicle to stop immediately.

At 632, the apparatus may determine whether the obstacles have been moved or removed. If the obstacles have been moved or removed, the apparatus may loop back to 616. Otherwise, the apparatus may proceed to 634.

At 634, the apparatus may instruct the vehicle to wait for a period of time. In one embodiment, the apparatus may instruct the vehicle to stay still and send a note to the server. The apparatus may then loop back to 632.

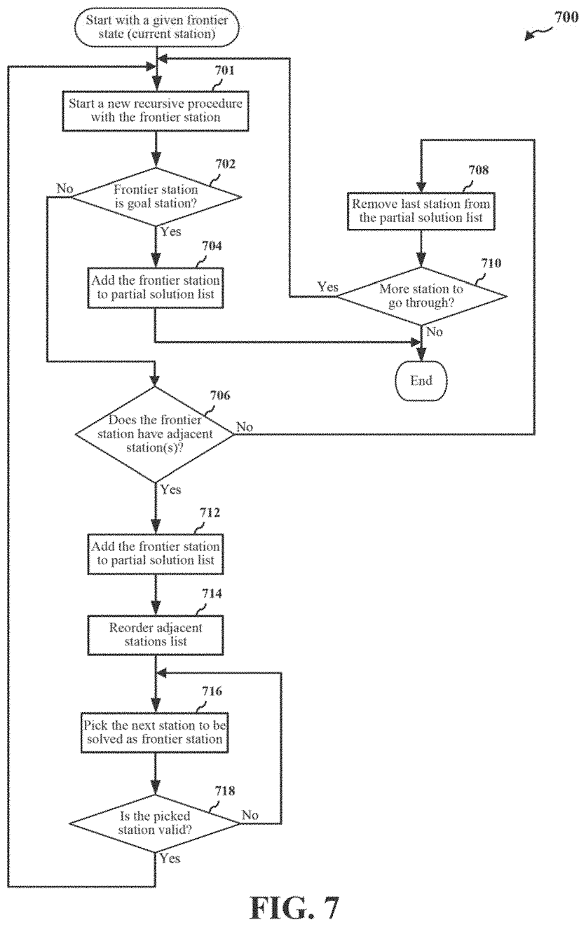

FIG. 7 is a flowchart 700 of a method of vehicle path planning. The method may be performed by an apparatus. The apparatus may include a vehicle (e.g., the vehicle 110, 112, or 114), or a server (e.g., the server 104), or a combination of the vehicle and the server. The method may be initially given a frontier station (e.g., the current station of the vehicle). In one embodiment, the operations performed by the method may be the operations described above with reference to 530, 540, 544, or 516 in FIG. 5.

At 701, the apparatus may start a new recursive procedure with the frontier station (the current station). At 702, the apparatus may determine whether the frontier station is the goal/destination station. If the frontier station is the goal/destination station, the apparatus may proceed to 704. Otherwise, the apparatus may proceed to 706.

At 704, the apparatus may add the frontier station to a partial solution list. The apparatus may then proceed to terminate the method.

At 706, the apparatus may determine whether the frontier station has one or more adjacent stations. If the frontier station does not have any adjacent station, the apparatus may proceed to 708. Otherwise, the apparatus may proceed to 712.

At 708, the apparatus may remove the last added station from the partial solution list. At 710, the apparatus may determine whether there are more stations to go through. If there are more stations to go through, the apparatus may loop back to 701. Otherwise, the apparatus may terminate the method.

At 712, the apparatus may add the frontier station to the partial solution list. At 714, the apparatus may reorder the list of stations that are adjacent to the frontier station based on their weights (heuristic values calculated for the adjacent stations). In one embodiment, the heuristic values may be calculated as (Path_costs+Stations_or_path_crowdedness+Stations_or_path_accessibility−Path_charging_breaks)×(−1). In such an embodiment, the station with the highest heuristic value may be selected first.

At 716, the apparatus may pick the next station to be solved as the frontier station. At 718, the apparatus may determine whether the picked station is valid. In one embodiment, the picked station may be valid if it is not visited, not inaccessible, and no constraint is violated by picking the station. If the picked station is valid, the apparatus may loop back 701 start a new iteration. Otherwise, the apparatus may loop back to 716 to pick a new station.

Constraint Satisfaction (CS) is central to intelligent behaviour and designing an efficient search algorithm is a part of on-going efforts. Search is the most fundamental process of exploring and navigating through a problem search space. Thus, search has been considered as the gist of problem solving in artificial intelligence. Search algorithms take a lot of rational decisions as the searching process progresses based on some predefined heuristics. However, decisions are sometimes made based on nothing but random tie-breaking functions. The quality of the decision made may rely on the awareness of available and accessible information of the problem. This awareness may be obtained by an effective exploring strategy to the problem space. Nevertheless, the way of solving Constraint Satisfaction Problems (CSPs) evolves slowly and no substantial progress has been made since the beginning of this field.

CSP is a mathematical combinatorial problem that involves searching process of finding a finite set of valid answers (Values) among other given candidates, to a finite set of questions (Variables), without violating a third finite set of restrictions (Constraints). A constraint is a restriction on a domain of potential answers, which is a necessary piece of information that helps to identify valid values.

Most artificial intelligence (AI) problems may be presented in or formulated as CSP with all of its characteristics, and may be solved using some well-known CSP solvers. The algorithms that can be used to solve CSPs may fall into two main categories: deductive algorithms and search algorithms. Deductive algorithms may apply a human-like approach in which the algorithms search for patterns to eliminate invalid candidates and assign values to states with a single legal candidate. No estimation is performed in deductive algorithms. Search algorithms are brute-force type searches through predefined sets of potential candidates using the ‘trial and error’ approach.

Search algorithms dedicated to solve CSP are efficient, especially when coupled with efficient strategies like Forward Checking (FC) and Minimum Remaining Values (MRV). However, many strategies for CSP search algorithms confront a paradox known as Fog of Search (FoS) when they come across with a set of variables that all have equal heuristic value or when the domain of a selected state has more than one candidate. Consequently, selecting an arbitrary random variable or values takes place as a common practical procedure of breaking ties. If the main purpose of using strategies and heuristic values is to identify the most promising state to assign, then taking random actions indicates the strategy's inability to achieve the purpose.

Contribution Number (CtN) strategy aims to eliminate or reduce the amount of random selection made by MRV strategy. The idea of CtN is to alternate the ultimate objective of the search algorithm from solving it to neutralize it. Traditional strategies reinforce the notion of maintaining the algorithm engaged in searching process as long as there is one or more state without assigned values. As a result, the explored nodes required to solve any CSP are at least equal to the number of unlabeled states (variables) at the initial position in the best-case scenario (assuming no backtracking occurs).

The neutralization concept may cover two different levels: neutralized state and neutralized problem. Neutralized state is a CSP state with only one candidate, and all its peers' candidates are not affected by solving the state. Any engagement with the neutralized state may be considered as a redundant iterative recursion in the solving process. Neutralized problem is a CSP where all the unlabelled states are neutralized. In the case of neutralized problem, the solver may have to declare the problem as a ‘Neutralized CSP’, and all searching activities have to be terminated.

A CSP neutralized configuration may be mathematically described as follows:

$$NtN = \frac{TUS}{TRC} = 1$$

where NtN (Neutralization Number) is the result of dividing TUS (Total number of unlabelled states) over TRC (Total number of Remaining Candidates). A problem is neutralized when NtN is equal to 1. However, most of the time the total number of remaining candidates is larger than the total number of unlabelled states (which makes NtN less than 1). The objective of the strategy is to reduce the number of TRC to be equal to TUS as fast as possible.

CtN is a strategy for selecting optimal states. Thus, the strategy selects the states with minimum remaining values, and then assesses them by assigning weights based on their influences on their peers. The state with the highest CtN is to be selected first as a new frontier.

The heuristic value produced by the CtN strategy may be mathematically described as follows:

$${CtN}_{k} = \frac{{\sum }_{i = 1}^{{n}_{k}} {\sum }_{j = 1}^{\vert {P}_{i} \vert} ( {d}_{j} ∈ {P}_{k} )}{\vert {P}_{k} \vert}$$

Since the objective is to deduct as many candidates as possible from the selected variable's peers per each value assignment to reduce TRC as much as it possible, the evaluation process starts with selecting the current variable (k) from the received list of potential states, then iterates through all its unassigned peers and checks similar candidates within the state peers dⱼ ∈ Pₖ. Assuming there are SPₖ number of peers for each state, all the peers except those with assigned values ARₖ may need to be visited. In this case, n (which denotes the count number of the unassigned peers for the current cell k) is equal to:

nₖ=SPₖ−|ARₖ|

where ARₖ is a set of all assigned states of the current state k. Thus, by computing nₖ (which is limited to 1≤n≤SPₖ), the number of unassigned peers associated to the current cell k is identified. The next step is to select one of those blank states P and iterate through all its candidates d using the counter j to determine whether one is a member of the current cell candidate set (Pₖ); if such is the case, the counter is increased by one.

Most of the real-life problems confronted by a robot can be mathematically formulated as a CSP. In one embodiment, in order to enhance the speed of the solving process, the algorithm may not try to label all unassigned states. Rather, the problem may be neutralized by making sure that all unassigned states are left with only one valid candidate in their domains.

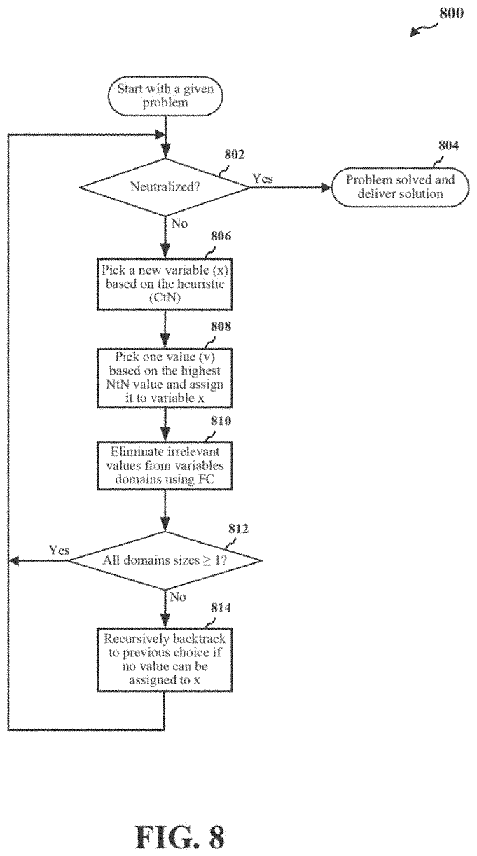

FIG. 8 is a flowchart 800 of a method of robot problem solving. The method may be performed by an apparatus. The apparatus may include a vehicle (e.g., the vehicle 110, 112, or 114), or a server (e.g., the server 104), or a combination of the vehicle and the server. The method may intended to solve a given problem. In one embodiment, the operations performed by the method may be the operations described above with reference to 528, 530, 540, 542, 544, or 516 in FIG. 5, or 606, 608 in FIG. 6, or 714 in FIG. 7.

At 802, the apparatus may determine whether the problem is neutralized. If the problem is neutralized, the apparatus may proceed to 804. Otherwise, the apparatus may proceed to 806.

At 804, the apparatus may indicate that the problem has been solved and deliver the solution. The apparatus may then terminate the method.

At 806, the apparatus may pick a new variable x based on the heuristic value of CtN. At 808, the apparatus may pick a value v based on the highest heuristic value of NtN and assign it to variable x. At 810, the apparatus may eliminate irrelevant values from variables domains using Forward Checking (FC) strategy.

At 812, the apparatus may determine whether all domains sizes are greater than or equal to ‘1’. If all domains sizes are greater than or equal to ‘1’, the apparatus may loop back to 802. Otherwise, the apparatus may proceed to 814.

At 814, the apparatus may recursively perform backtracking to previous choice if no value can be assigned to x or any other remaining state. The apparatus may then loop back to 802.

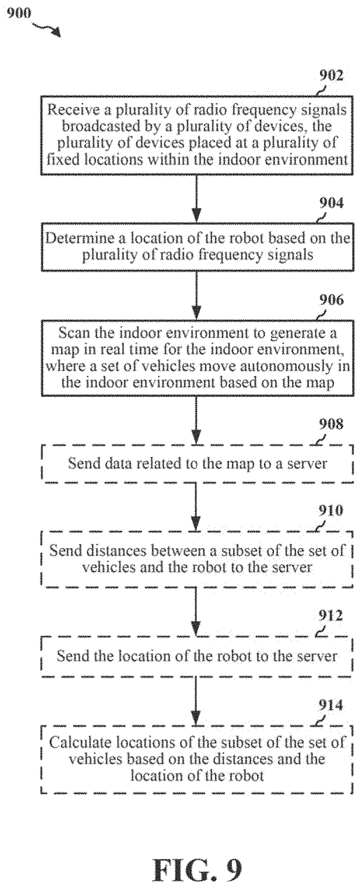

FIG. 9 is a flowchart 900 of a method of performing mapping and localization by the robots. The method may manage autonomous vehicles within an indoor environment. The method may be performed by an apparatus. The apparatus may include a robot (e.g., the robot 132, 134, or 136), or a server (e.g., the server 104), or a combination of the robot and the server.

At 902, the apparatus may receive a plurality of radio frequency signals broadcasted by a plurality of devices (e.g., the beacons 120, 122, 124, 126). The plurality of devices placed at a plurality of fixed locations within the indoor environment. In one embodiment, the plurality of radio frequency signals may include a plurality of identifiers of the plurality of devices.

At 904, the apparatus may determine a location of the robot based on the plurality of radio frequency signals. In one embodiment, to determine the location of the robot based on the plurality of radio frequency signals, the apparatus may determine the plurality of fixed locations associated with the plurality of devices based on the plurality of identifiers, measure a plurality of distances from the plurality of devices to the robot based on the plurality of radio frequency signals, and calculate the location of the robot based on the plurality of fixed locations and the plurality of distances from the plurality of devices to the robot.

At 906, the apparatus may scan the indoor environment to generate a map (e.g., the routing map 204) in real time for the indoor environment. A set of vehicles (e.g., the vehicles 110, 112, 114) may move autonomously in the indoor environment based on the map. In one embodiment, the map may be a routing map (e.g., the routing map 204) including a plurality of virtual paths and a plurality of virtual stations. In one embodiment, the apparatus may further detect that a subset of the plurality of virtual paths or a subset of the plurality of virtual stations becomes inaccessible. In one embodiment, the robot may generate the map based on the location of the robot.

At 908, the apparatus may optionally send data related to the map to a server (e.g., the server 104). At 910, the apparatus may optionally send distances between a subset of the set of vehicles and the robot to the server to increase measurement precision. In one embodiment, the robot may receive a radio frequency signal broadcasted by the vehicle, where the distance from the robot to the vehicle may be measured based on the radio frequency signal.

At 912, the apparatus may optionally send the location of the robot to the server. At 914, the apparatus may optionally calculate locations of the subset of the set of vehicles based on the distances and the location of the robot. In one embodiment, the location of a vehicle within the set of vehicles may be determined based on the location of the robot and a distance from the robot to the vehicle.

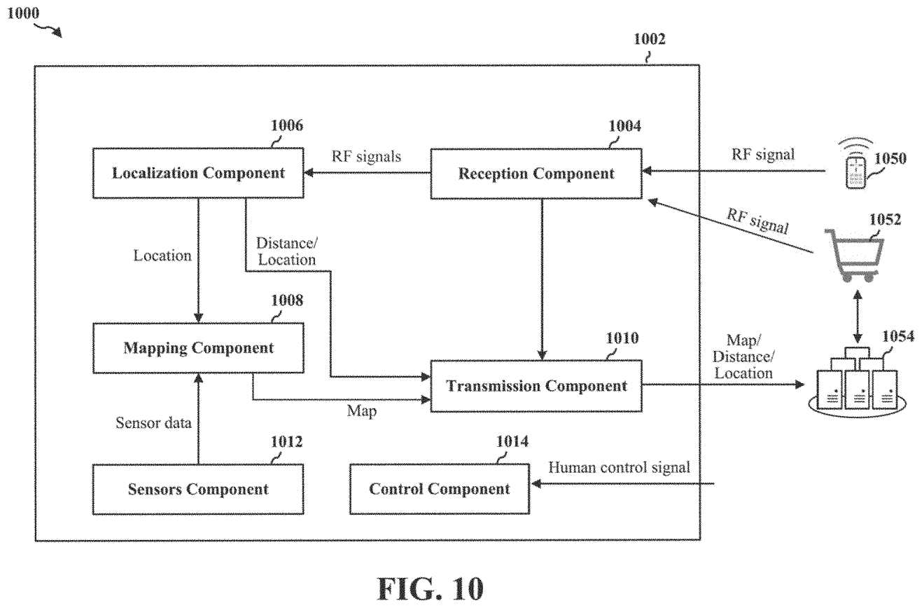

FIG. 10 is a conceptual data flow diagram 1000 illustrating the data flow between different means/components in an exemplary apparatus 1002. The apparatus 1002 may be a robot (e.g., the robot 132, 134, or 136). The apparatus 1002 may include a reception component 1004 that receives a first RF signal from a beacon 1050 and a second RF signal from a vehicle 1052. In one embodiment, the reception component 1004 may perform the operations described above with reference to 902 in FIG. 9.

The apparatus 1002 may include a transmission component 1010 that transmits map information, distances between the apparatus 1002 to the vehicle 1052, and/or the location of the apparatus 1002 to the server 1054. In one embodiment, the transmission component 1010 may perform the operations described above with reference to 908, 910, or 912 in FIG. 9. The reception component 1004 and the transmission component 1010 may collaborate to coordinate the communication of the apparatus 1002.

The apparatus 1002 may include a localization component 1006 that is configured to determine the location of the apparatus and the distance from the apparatus to the vehicle 1052 based on the received RF signals. In one embodiment, the localization component 1006 may perform the operations described above with reference to 904 in FIG. 9.

The apparatus 1002 may include a mapping component 1008 that generates a map of the indoor environment based on the location of the apparatus 1002 and sensor data. In one embodiment, the mapping component 1008 may perform the operations described above with reference to 906 in FIG. 9.

The apparatus 1002 may include a sensors component 1012 that gathers sensor data. The gathered sensor data may be analyzed and transmitted to help the system in keeping the map updated.

The apparatus 1002 may include a control component 1014 that enables human agent to control the apparatus 1002 without referring to the server 1054. The apparatus 1002 in this case takes direction from its operator not from the server 1054.

The apparatus 1002 may include additional components that perform each of the blocks of the algorithm in the aforementioned flowchart of FIGS. 5-9. As such, each block in the aforementioned flowchart of FIGS. 5-9 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

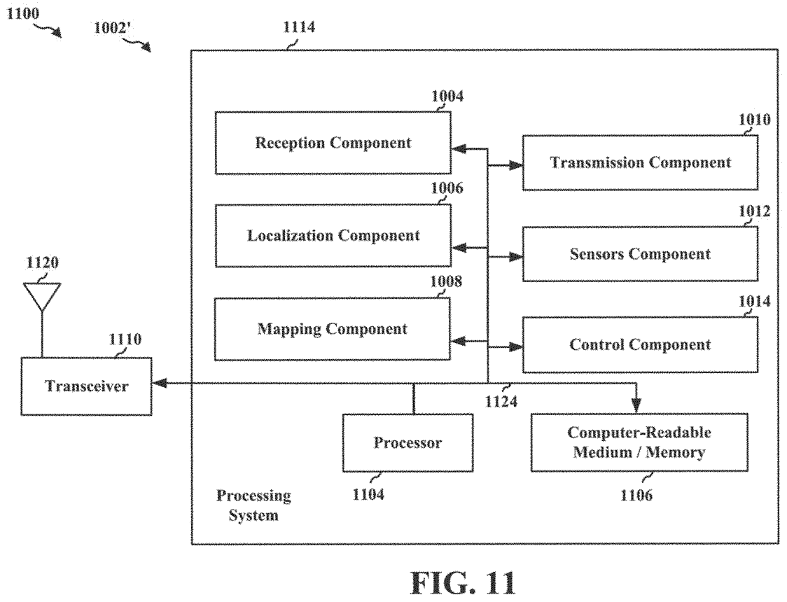

FIG. 11 is a diagram 1100 illustrating an example of a hardware implementation for an apparatus 1002′ employing a processing system 1114. In one embodiment, the apparatus 1002′ may be the apparatus 1002 described above with reference to FIG. 10. The processing system 1114 may be implemented with a bus architecture, represented generally by the bus 1124. The bus 1124 may include any number of interconnecting buses and bridges depending on the specific application of the processing system 1114 and the overall design constraints. The bus 1124 links together various circuits including one or more processors and/or hardware components, represented by the processor 1104, the components 1004, 1006, 1008, 1010, 1012, 1014, and the computer-readable medium/memory 1106. The bus 1124 may also link various other circuits such as timing sources, peripherals, voltage regulators, and power management circuits, which are well known in the art, and therefore, will not be described any further.

The processing system 1114 may be coupled to a transceiver 1110. The transceiver 1110 is coupled to one or more antennas 1120. The transceiver 1110 provides a means for communicating with various other apparatus over a transmission medium. The transceiver 1110 receives a signal from the one or more antennas 1120, extracts information from the received signal, and provides the extracted information to the processing system 1114, specifically the reception component 1004. In addition, the transceiver 1110 receives information from the processing system 1114, specifically the transmission component 1010, and based on the received information, generates a signal to be applied to the one or more antennas 1120.

The processing system 1114 includes a processor 1104 coupled to a computer-readable medium/memory 1106. The processor 1104 is responsible for general processing, including the analyzation of data gathered by the apparatus itself through its own sensors and the execution of software stored on the computer-readable medium/memory 1106. The software, when executed by the processor 1104, causes the processing system 1114 to perform the various functions described supra for any particular apparatus. The computer-readable medium/memory 1106 may also be used for storing data that is manipulated by the processor 1104 when executing software. The processing system 1114 further includes at least one of the components 1004, 1006, 1008, 1010, 1012, 1014. The components may be software components running in the processor 1104, resident/stored in the computer readable medium/memory 1106, one or more hardware components coupled to the processor 1104, or some combination thereof. The processor 1104 may also be responsible for executing orders coming from the control component 1014. This may help human agent to take over the apparatus whenever the control mode is switched to manual. In this particular case the apparatus would stop executing orders coming from the server (or delay them) unless the order that is coming from the server is classified in “safety” category.

In the following, various aspects of this disclosure will be illustrated:

Example 1 is a system for managing autonomous vehicles within an indoor environment. The system may include a plurality of devices placed at a plurality of fixed locations within the indoor environment. The system may include a plurality of robots configured to automatically scan the indoor environment to contribute in generating a map in real time for the indoor environment. The robots may keep building the map partially and updating it and the process of building the map takes infinite time. Each robot of the plurality of robots may determine the location of itself or another robot using a subset of the plurality of devices. The system may include a set of vehicles configured to move autonomously, remotely, or manually in the indoor environment based on the map.

In Example 2, the subject matter of Example 1 may optionally include that the map may be a routing map comprising a plurality of virtual paths and a plurality of virtual stations.

In Example 3, the subject matter of Example 2 may optionally include that the plurality of robots may further detect that a subset of the plurality of virtual paths or a subset of the plurality of virtual stations becomes inaccessible.

In Example 4, the subject matter of any one of Examples 1 to 3 may optionally include that, for each robot of the plurality of robots, to determine the location of itself or another robot using the subset of the plurality of devices, the robot may be configured to: receive a plurality of radio frequency signals broadcasted by the subset of the plurality of devices, the plurality of radio frequency signals including identifiers of the subset of the plurality of devices; determine locations of the subset of the plurality of devices based on the identifiers; measure distances from the subset of the plurality of devices to the robot based on the plurality of radio frequency signals; and calculate the location of the robot based on the fixed locations of the subset of the plurality of devices and the distances from the subset of the plurality of devices to the robot.

In Example 5, the subject matter of any one of Examples 1 to 4 may optionally include that, for each vehicle of the set of vehicles, the location of the vehicle may be determined based on locations of a subset of the plurality of robots and distances from the subset of the plurality of robots to the vehicle.

In Example 6, the subject matter of any one of Examples 1 to 5 may optionally include that, for each vehicle of the set of vehicles, each robot of the subset of the plurality of robots may receive a radio frequency signal broadcasted by the vehicle, where the distances from the subset of the plurality of robots to the vehicle may be measured based on the radio frequency signal received by the subset of the plurality of robots.

In Example 7, the subject matter of any one of Examples 1 to 6 may optionally include that the system may further include a server configured to receive data related to the map from the plurality of robots, and to help in governing the environment by sending instructions to the deployed robots.

In Example 8, the subject matter of Example 7 may optionally include that the server may be further configured to: receive, from each robot of the plurality of robots, distances between a subset of the set of vehicles and the robot; receive the locations of the plurality of robots; and calculate locations of the set of vehicles based on the received distances and the received locations of the plurality of robots; receive information related to the map from robot sensors and keep robots locations updated relevantly to their positions on the map.

In Example 9, the subject matter of any one of Examples 1 to 8 may optionally include that the plurality of robots may generate the map based on the locations of the plurality of robots. The plurality of robots may generate the map partially based on sensing the open paths and calculating the distances between the pluralities of robots.

Example 10 is a method or apparatus for managing autonomous vehicles within an indoor environment. The apparatus may receive a plurality of radio frequency signals broadcasted by a plurality of devices. The plurality of devices may be placed at a plurality of fixed locations within the indoor environment. The apparatus may determine the location of the robot based on the plurality of radio frequency signals. The apparatus may scan the indoor environment to generate at least a partial part of the map in real time for the indoor environment or update it if the place has already been visited. A set of vehicles may move autonomously in the indoor environment based on the map.

In Example 11, the subject matter of Example 10 may optionally include that the map may be a routing map including a plurality of virtual paths and a plurality of virtual stations.

In Example 12, the subject matter of Example 11 may optionally include that the apparatus may further detect that a subset of the plurality of virtual paths or a subset of the plurality of virtual stations becomes inaccessible.

In Example 13, the subject matter of any one of Examples 10 to 12 may optionally include that the plurality of radio frequency signals may include a plurality of unique identifiers of the plurality of devices. To determine the location of the robot based on the plurality of radio frequency signals, the apparatus may determine the plurality of fixed locations associated with the plurality of devices based on the plurality of identifiers, measure a plurality of distances from the plurality of devices to the robot based on the plurality of radio frequency signals, and calculate the location of the robot based on the plurality of fixed locations and the plurality of distances from the plurality of devices to the robot.

In Example 14, the subject matter of any one of Examples 10 to 13 may optionally include that the location of a vehicle within the set of vehicles may be determined based on the location of the robot and the distance from the robot to the vehicle.

In Example 15, the subject matter of any one of Examples 10 to 14 may optionally include that the robot may receive a radio frequency signal broadcasting the identifier of the vehicle, where the distance from the robot to the vehicle may be measured based on the radio frequency signal.

In Example 16, the subject matter of any one of Examples 10 to 15 may optionally include that the apparatus may further send data related to the map to a server.

In Example 17, the subject matter of Example 16 may optionally include that the apparatus may further send distances between a subset of the set of vehicles and the robot to the server, send the location of the robot to the server, and calculate locations of the subset of the set of vehicles based on the distances and the location of the robot. The apparatus may interact with direct commands coming from the control component (by human agent) or from the reception component (by the server). The apparatus may further analyze the gathered information from the sensors.

In Example 18, the subject matter of any one of Examples 10 to 17 may optionally include that the robot may contribute in generating the map by sensing the open paths.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof' may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A system for managing autonomous vehicles within an indoor environment, comprising:
a plurality of devices placed at a plurality of fixed locations within the indoor environment;
a plurality of robots configured to automatically scan the indoor environment to contribute in generating a map in real time for the indoor environment, wherein each robot of the plurality of robots determines a location of the robot using a subset of the plurality of devices; and
a set of vehicles configured to move autonomously in the indoor environment based on the map,
wherein, for each vehicle of the set of vehicles, a location of the vehicle is determined based on locations of a subset of the plurality of robots and distances from the subset of the plurality of robots to the vehicle, wherein, for each vehicle of the set of vehicles, each robot of the subset of the plurality of robots receives a radio frequency signal broadcasted by the vehicle, wherein the distances from the subset of the plurality of robots to the vehicle are measured based on the radio frequency signal received by the subset of the plurality of robots.

2. The system of claim 1, wherein the map is a routing map comprising a plurality of virtual paths and a plurality of virtual stations, wherein the plurality of robots further detects that a subset of the plurality of virtual paths or a subset of the plurality of virtual stations becomes inaccessible.

3. The system of claim 1, wherein, for each robot of the plurality of robots, to determine the location of the robot using the subset of the plurality of devices, the robot is configured to:
receive a plurality of radio frequency signals broadcasted by the subset of the plurality of devices, the plurality of radio frequency signals comprising identifiers of the subset of the plurality of devices;
determine locations of the subset of the plurality of devices based on the broadcasted identifiers;
measure distances from the subset of the plurality of devices to the robot based on the plurality of radio frequency signals; and
calculate the location of the robot based on the fixed locations of the subset of the plurality of devices and the distances from the subset of the plurality of devices to the robot.

4. The system of claim 1, further comprising a server configured to receive data related to the map from the plurality of robots.

5. The system of claim 4, wherein the server is further configured to:
receive, from each robot of the plurality of robots, distances between a subset of the set of vehicles and the robot;
receive the locations of the plurality of robots; and
calculate locations of the set of vehicles based on the received distances and the received locations of the plurality of robots.

6. The system of claim 1, wherein the plurality of robots generate the map partially based on sensing open paths and calculating distances between the plurality of robots.

7. A method of managing autonomous vehicles within an indoor environment, the method comprising:
receiving, by a robot, a plurality of radio frequency signals broadcasted by a plurality of devices, the plurality of devices placed at a plurality of fixed locations within the indoor environment;
determining a location of the robot based on the plurality of radio frequency signals; and
scanning, by the robot, the indoor environment to generate at least a partial part of a map in real time for the indoor environment, wherein a set of vehicles move autonomously in the indoor environment based on the map,
wherein a location of a vehicle within the set of vehicles is determined based on the location of the robot and a distance from the robot to the vehicle, wherein the robot receives a radio frequency signal broadcasting an identifier of the vehicle, wherein the distance from the robot to the vehicle is measured based on the radio frequency signal.

8. The method of claim 7, wherein the map is a routing map comprising a plurality of virtual paths and a plurality of virtual stations, wherein the method further comprises:
detecting that a subset of the plurality of virtual paths or a subset of the plurality of virtual stations becomes inaccessible.

9. The method of claim 7, wherein the plurality of radio frequency signals comprising a plurality of identifiers of the plurality of devices, wherein the determining of the location of the robot based on the plurality of radio frequency signals comprises:
determining the plurality of fixed locations associated with the plurality of devices based on the plurality of identifiers;
measuring a plurality of distances from the plurality of devices to the robot based on the plurality of radio frequency signals; and
calculating the location of the robot based on the plurality of fixed locations and the plurality of distances from the plurality of devices to the robot.

10. The method of claim 7, further comprising sending, by the robot, data related to the map to a server.

11. The method of claim 10, further comprising:
sending, by the robot, distances between a subset of the set of vehicles and the robot to the server;
sending, by the robot, the location of the robot to the server; and
calculating locations of the subset of the set of vehicles based on the distances and the location of the robot.

12. The method of claim 7, wherein the robot generates the map based on the location of the robot.

13. An apparatus for managing autonomous vehicles within an indoor environment, the apparatus comprising:
a memory; and
at least one processor coupled to the memory and configured to:
receive a plurality of radio frequency signals broadcasted by a plurality of devices, the plurality of devices placed at a plurality of fixed locations within the indoor environment;
determine a location of a robot based on the plurality of radio frequency signals;
scan the indoor environment to generate a map in real time for the indoor environment, wherein a set of vehicles move autonomously in the indoor environment based on the map;
send data related to the map to a server;
send, to the server, distances between a subset of the set of vehicles and the robot;
send, to the server, the location of the robot; and
calculate locations of the subset of the set of vehicles based on the distances and the location of the robot.

14. The apparatus of claim 13, wherein the map is a routing map comprising a plurality of virtual paths and a plurality of virtual stations, wherein the at least one processor is further configured to:
detect that a subset of the plurality of virtual paths or a subset of the plurality of virtual stations becomes inaccessible.

15. The apparatus of claim 13, wherein the plurality of radio frequency signals comprising a plurality of unique identifiers of the plurality of devices, wherein, to determine the location of the robot based on the plurality of radio frequency signals, the at least one processor is configured to:
determine the plurality of fixed locations associated with the plurality of devices based on the plurality of identifiers;
measure a plurality of distances from the plurality of devices to the robot based on the plurality of radio frequency signals; and
calculate the location of the robot based on the plurality of fixed locations and the plurality of distances from the plurality of devices to the robot.

16. The apparatus of claim 15, wherein the at least one processor is further configured to:
interact with direct commands coming from a control component or from a reception component; and
analyze gathered information from sensors.

17. The apparatus of claim 13, wherein the map is generated based on the location of the robot.
